(19) United States
(12) Patent Application Publication
(10) Pub. No.: US 2023/0022688 A1
(43) Pub. Date: Jan. 26, 2023

(54) LASER DISTANCE MEASURING DEVICE, LASER DISTANCE MEASURING METHOD, AND MOVABLE PLATFORM

(71) Applicant: SZ DJI TECHNOLOGY CO., LTD., Shenzhen (CN)

(72) Inventors: Xiaoping HONG, Shenzhen (CN); Xiao HUANG, Shenzhen (CN); Liangliang MA, Shenzhen (CN); Guoguang ZHENG, Shenzhen (CN)

(73) Assignee: SZ DJI TECHNOLOGY CO., LTD., Shenzhen (CN)

(21) Appl. No.: 17/958,427

(22) Filed: Oct. 2, 2022

Related U.S. Application Data
(63) Continuation of application No. PCT/CN2020/083300, filed on Apr. 3, 2020.

(51) Int. Cl. G01S 17/10; G01S 7/481; G01S 7/4863

(52) U.S. Cl. CPC G01S 17/10; G01S 7/4814; G01S 7/4816; G01S 7/4863

(57) ABSTRACT

A laser distance measuring device, a laser distance measuring method, and a movable platform are provided. The laser distance measuring device includes a transmitting module and a receiving module. The transmitting module includes a transmitting circuit and an optical transmitting system, the transmitting circuit is configured to transmit laser pulses, and the optical transmitting system is configured to disperse the laser pulse, to make the laser pulses cover a designated field-of-view area. The receiving module includes a receiving circuit and an optical receiving system, the receiving circuit includes an APD array operating in a linear mode and is configured to receive at least some of returning laser pulses upon the laser pulses being reflected back by a measured object, and convert the at least some of the returning laser pulses into an electrical signal.

### RELATED APPLICATIONS

This application is a continuation application of PCT application No. PCT/CN2020/083300, filed on Apr. 3, 2020, and the content of which is incorporated herein by reference in its entirety.

### TECHNICAL FIELD

The present disclosure generally relates to the field of laser distance measuring technologies, and more particularly, to a laser distance measuring device, a laser distance measuring method, and a movable platform.

### BACKGROUND

Lidar obtains distance information of a detected object by actively transmitting and receiving laser pulses and performing calculations based on information such as a flight time difference or a phase difference of laser echo signals. As an advanced sensor device that may perceive three-dimensional information of an environment, lidar has been widely used in various fields of intelligent robots and autonomous driving in recent years.

In order to implement three-dimensional information perception characterized by wide field of view, large range, and high precision, current lidar products adopt a relatively complex system structure. Especially, to improve the detection efficiency, a plurality of independent sensing units is needed, and an optical path(s) needs to be accurately calibrated. As a result, a system structure is complex, and automated assembly is difficult, greatly affecting mass producibility and production costs of lidar. In addition, in order to implement large-range detection by using a small number of sensing units, a scanning system often needs to be introduced for operations such as mechanical scanning. Consequently, moving parts greatly reduce reliability and service life of a lidar system, and the lidar system fails to adapt to requirements such as high vibrations, large working temperature range, and long working cycle during automatic driving, and the like.

### BRIEF SUMMARY

The Summary introduces a series of concepts in a simplified form that will be further described in detail in the Detailed Description. The Summary of the present disclosure is not intended to define key features and essential technical features of the claimed technical solutions, nor is it intended to determine the protection scopes of the claimed technical solutions.

In order to overcome defects in the existing technologies, a first aspect of some exemplary embodiments of the present disclosure provides a laser distance measuring device. The laser distance measuring device includes a transmitting module, including: a transmitting circuit configured to transmit laser pulses, and an optical transmitting system configured to disperse the laser pulses to cover a target field-of-view area; and a receiving module, including: a receiving circuit, including an avalanche photodiode (APD) array operating in a linear mode, and configured to: receive at least some of returning laser pulses as the laser pulses are reflected back by a measured object, and convert the at least some of the returning laser pulses into an electrical signal, and an optical receiving system, configured to converge the returning laser pulses on the APD array.

A second aspect of some exemplary embodiments of the present disclosure provides a laser distance measuring device, and the laser distance measuring device includes a transmitting module, including: a transmitting circuit including a plurality of transmitting units to sequentially emit laser pulses, and an optical transmitting system configured to disperse the laser pulses transmitted by each of the transmitting units to a corresponding sub-field-of-view area of a target field-of-view area; and a receiving module, including: a receiving circuit, including a plurality of receiving units, and configured to: receive at least some of the returning laser pulses as the laser pulses are reflected back by a measured object, and convert the at least some of the returning laser pulses into an electrical signal, and an optical receiving system, configured to converge the returning laser pulses of the sub-field-of-view areas on the receiving circuit.

A third aspect of some exemplary embodiments of the present disclosure provides a movable platform, and the movable platform includes: a movable platform body; and a laser distance measuring device disposed on the movable platform body, including: a transmitting module, including: a transmitting circuit configured to transmit laser pulses, and an optical transmitting system configured to disperse the laser pulses to cover a target field-of-view area, and a receiving module, including: a receiving circuit, including an avalanche photodiode (APD) array operating in a linear mode and configured to: receive at least some of returning laser pulses as the laser pulses are reflected back by a measured object, and convert the at least some of the returning laser pulses into an electrical signal, and an optical receiving system, configured to converge the returning laser pulses on the APD array.

According to the laser distance measuring device, the laser distance measuring method, and the movable platform of some exemplary embodiments of the present disclosure, an APD array operating in a linear mode is used, so that its distance measurement range is large, its dynamic range is wide, and its signal-to-noise ratio is high. Therefore, interference of ambient light noise on a laser distance measuring device may be effectively reduced, and the laser distance measuring device may be adapted to a complex use environment. In addition, a design in which a plurality of transmitting units perform transmission in a time-division manner and transmitting units and receiving units are in a one-to-one correspondence is employed, and no mechanical moving parts are needed, so that the laser distance measuring device is small and light-weighted. There is no need to align the transmitting units and the receiving units one by one for assembly, so that low assembly difficulty, good mass producibility, and high reliability can be achieved.

### BRIEF DESCRIPTION OF THE DRAWINGS

To describe the technical solutions in some exemplary embodiments of the present disclosure more clearly, the following briefly describes the accompanying drawings for some exemplary embodiments. Apparently, the accompanying drawings in the following description show merely some exemplary embodiments of the present disclosure, and a person of ordinary skill in the art may still derive other drawings from these accompanying drawings without creative efforts.

FIG. 1 is a structural block diagram of a laser distance measuring device according to some exemplary embodiments of the present disclosure;

FIG. 2 is a schematic diagram of a spatial layout of a laser distance measuring device according to some exemplary embodiments of the present disclosure;

FIG. 3 is a schematic diagram of an operating state of a laser distance measuring device in a single time window according to some exemplary embodiments of the present disclosure;

FIG. 4 is a principle diagram of a laser drive circuit according to some exemplary embodiments of the present disclosure;

FIG. 5 is a structural block diagram of a laser distance measuring device according to some exemplary embodiments of the present disclosure; and

FIG. 6 is a schematic flow char of a laser distance measuring method according to some exemplary embodiments of the present disclosure.

### DETAILED DESCRIPTION

In order to make the objectives, technical solutions and advantages of the present disclosure clear, some exemplary embodiments of the present disclosure will be described in detail below with reference to the accompanying drawings. Apparently, the described exemplary embodiments are merely some rather than all of the embodiments of the present disclosure, and it should be understood that, the present disclosure is not limited by the exemplary embodiments described herein. All other embodiments obtained by those skilled in the art based on these exemplary embodiments of the present disclosure described in the present disclosure without creative efforts shall fall within the protection scope of the present disclosure.

In the following description, numerous specific details will be provided to facilitate a more thorough understanding of the present disclosure. However, it is obvious for those skilled in the art that the present disclosure may be implemented without using some or all of these details. In other examples, some technical features known in the art are not described in order to avoid confusion with the present disclosure.

It should be understood that, the present disclosure can be embodied in many different forms and should not be construed as being limited to the exemplary embodiments set forth herein. On the contrary, the exemplary embodiments are provided to make the present disclosure more thorough and complete and the scope of the present disclosure be fully conveyed to those skilled in the art.

The terms used herein are merely for the purpose of describing specific exemplary embodiments, and are not intended to limit the present disclosure. As used herein, unless the context clearly indicates otherwise, the singular forms “a”, “an”, and “the/this” are intended to include the plural forms as well. Moreover, it should be understood that the terms “compose” and/or “comprise”, when used in this disclosure, indicate the presence of described features, integers, steps, operations, elements and/or components, but do not exclude the presence or addition of one or more of other features, integers, steps, operations, elements, components, and/or sets thereof. As used herein, the term “and/or” includes any and all combinations of related items listed.

For a thorough understanding of the present disclosure, detailed structures will be presented in the following description in order to explain the technical solutions of the present disclosure. Some exemplary embodiments of the present disclosure will be described in detail below; however, the present disclosure may be implemented in some exemplary embodiments in addition to these detailed descriptions.

The laser distance measuring device of the present application will be described in detail below with reference to the accompanying drawings. If there is no conflict, the following exemplary embodiments and features may be combined to one another.

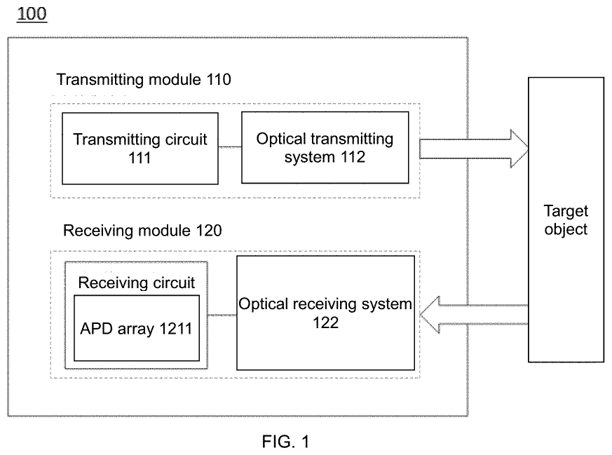

Firstly, a structure of a laser distance measuring device according to some exemplary embodiments of the present disclosure is exemplarily described in detail with reference to FIG. 1 to FIG. 4. The laser distance measuring device may be a lidar device. The laser distance measuring device may detect a distance from a measured object to the laser distance measuring device by measuring a time that a laser travels between the laser distance measuring device and the measured object, namely, Time-of-Flight (TOF).

As shown in FIG. 1, a laser distance measuring device 100 may include a transmitting module 110 and a receiving module 120. The transmitting module 110 may include a transmitting circuit 111 and an optical transmitting system 112, the transmitting circuit 111 may be configured to transmit laser pulse(s), and the optical transmitting system 112 may be configured to disperse the laser pulse(s), to make the laser pulses cover a designated field-of-view area (i.e., target field-of-view area). The receiving module 120 may include a receiving circuit 121 and an optical receiving system 122, and the receiving circuit 121 may include an avalanche photodiode (APD) array 1211 operating in a linear mode and is configured to receive at least some of returning laser pulses after the laser pulse, transmitted by the transmitting module 110, is reflected back by a measured object in the field-of-view area, and convert the at least some of the returning laser pulses into an electrical signal(s). The optical receiving system 122 may be configured to make the returning laser pulses converge on the APD array 1211.

The laser distance measuring device 100 according to some exemplary embodiments of the present disclosure may perform scanning, without a scanning system, through cooperation of the transmitting circuit 111, the optical transmitting system, the optical receiving system 122, and the receiving circuit 121, so that there is no need to accurately align the transmitting modules 110 and the receiving modules 120 one by one, and long-distance three-dimensional imaging may be implemented without a mechanical moving part.

In addition, the laser distance measuring device 100 according to some exemplary embodiments of the present disclosure may use the APD array 1211 operating in a linear mode to achieve a more optimized effect. Specifically, an operating mode of an APD generally includes a linear mode and a Geiger mode. When a bias voltage of the APD is lower than its avalanche voltage, a linear amplification effect is implemented on an incident photoelectron. Such operating state is referred to as the linear mode. In the linear mode, the higher a reverse voltage, the greater a gain. The APD amplifies input photoelectrons with equal gain to form a continuous current, and obtains a laser continuous echo signal with time information. When the bias voltage of the APD is higher than its avalanche voltage, the gain of the APD increases rapidly. In this case, absorption of a single photon may make an output current of a detector be saturated. Such operating state is referred to as the Geiger mode. Since a single photon may cause an avalanche when the APD operates in the Geiger mode, the APD operating in the Geiger mode is also referred to as a single-photon avalanche diode (SPAD).

Due to factors such as manufacturing process and cooperation with other modules, the conventional laser distance measuring devices generally perform photoelectric conversion by using APDs operating in the Geiger mode. APD arrays operating in the Geiger mode have low photon detection efficiency, and are highly susceptible to noise interference and prone to saturation failure under sunlight. The laser distance measuring device 100 of some exemplary embodiments of the present disclosure may use the APD array 1211 operating in the linear mode. Compared with the single-photon avalanche diode operating in the Geiger mode, the APD array 1211 may have a high photon detection probability and a large dynamic range, and may closely cooperate with another module(s) of the laser distance measuring device 100.

The APD array 1211 may be composed of a plurality of APDs, and the plurality of APDs may be arranged as an APD linear array or an APD planar array. For example, the APD array 1211 may be a matrix composed of M×N APDs, where M and N are any integers greater than 1. A size of an APD is at the micron scale, and a photon detection probability is generally greater than 50%.

The APD array 1211 may use a Si APD, a Ge APD, a InGaAs APD, a HgCdTe APD, and the like depending on different base semiconductor materials. Considering safety of human eyes and a demand for high-power lasers, the APD array 1211 may use the InGaAs APD or the HgCdTe APD with an operating wavelength of 1.5 μm, but not limited thereto.

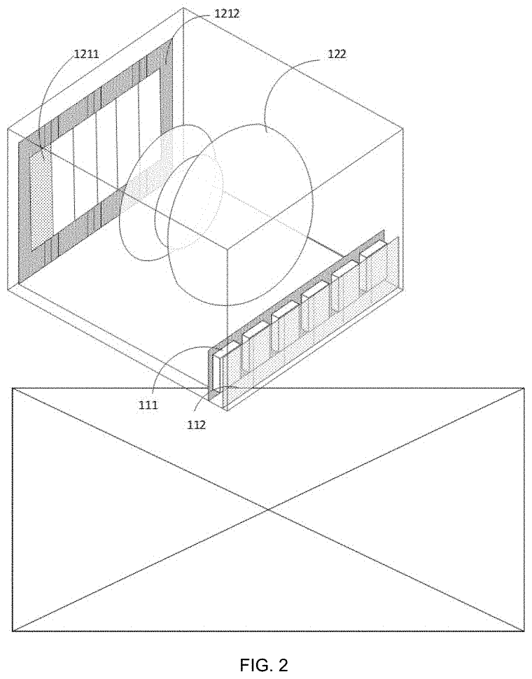

Referring to FIG. 2, the APD array 1211 may be interconnected with a signal processing chip 1212 at a pixel level. A light beam emitted by the transmitting module 110 is reflected by a measured object and then received by the optical receiving system 122. The optical receiving system 122 converges returning laser pulses returned by measured objects that are in different field-of-view areas in different positions of a photosensitive surface of the APD array 1211, respectively, and an APD at a corresponding position in the APD array performs photoelectric conversion to generate an electrical signal, and the electrical signal is then sent to the signal processing chip 1212 for signal processing.

As an example, the signal processing chip 1212 may include a complementary metal oxide semiconductor (CMOS) readout circuit chip (ROIC) in a time counting type, and the APD array 1211 may be integrated with the signal processing chip 1212 through a Z-stacking technology, a vertically integrated sensor array technology, or the like. The ROIC uses a silicon CMOS application-specific integrated circuit, which is mainly composed of a pre-amplifier circuit, a main amplifier, a comparator, a high-precision timing circuit and another module(s). A detector assembly may be formed by flip-chip integration of a ln column array and the APD array.

Further, the transmitting module 110 of the laser distance measuring device 100 according to some exemplary embodiment of the present disclosure may be configured to use a time-division and partitioning operating mode. In this operating mode, the transmitting module 110 may closely cooperate with the APD array 1211 operating in the linear mode.

Specifically, the transmitting circuit 111 may include a plurality of transmitting units, and each transmitting unit includes one or more lasers that emit light synchronously. The plurality of transmitting units may sequentially emit laser light in different time windows, and the optical transmitting system 112 disperses laser pulses transmitted by each of the transmitting units to a corresponding field-of-view area (i.e., sub-field-of-view area, or a subarea of the target field-of-view area). Due to a limited total power, the transmitting circuit 111 may be divided into a plurality of transmitting units that are turned on in different time windows, and then the power may be distributed to one or more lasers in each of the transmitting units, thereby increasing an optical power density per field of view, and helping increase a proportion of signal light of the photons arriving at the receiving module 120, improving a signal-to-noise ratio, and improving a measurement range of the laser distance measuring device 100 under a strong background light condition.

The APD array 1211 employed by the laser distance measuring device 100 in some exemplary embodiments of the present disclosure may operate in the linear mode, the dynamic range is wide, and saturation failure is less likely to occur. Therefore, the APD array 1211 may be used in cooperation with a higher-power transmitting unit. In contrast, an SPAD array operating in the Geiger mode may be in a state of severe saturation failure under a relatively strong background light condition, and increasing the optical power density per unit field-of-view is less helpful for improving the measurement range thereof under the strong background light condition.

In some exemplary embodiments, the laser may have a relatively high power, to meet a requirement for lasing over a long distance. The laser may include various types of lasers, such as a semiconductor laser (for example, a GaAlAs semiconductor diode laser), a solid-state laser (for example, an optical fiber laser, a neodymium-doped yttrium aluminum garnet laser, and a neodymium-doped yttrium vanadate laser), a gas laser (for example, a carbon dioxide laser, and a helium-neon laser), a liquid laser, a chemical laser, a free electron laser, etc. As an example, the laser may be a diode, such as a positive intrinsic negative (PIN) photodiode, to transmit a sequence of laser pulses of a specific wavelength.

In some exemplary embodiments, an operating parameter of the laser may be selected according to an actual need. For example, laser light of a corresponding wavelength range may be selected according to process maturity, costs, volumes, and performance parameters of the laser and a corresponding detector. For example, a semiconductor laser whose operating wavelength may range from 800 nanometers to 1000 nanometers and a silicon-based detector thereof are cost-effective and have a mature process, so that laser light with operating wavelength ranging from 800 nanometers to 1000 nanometers may be selected. For example, laser light of a corresponding wavelength range may be selected according to human visual safety. Since a degree of human visual safety is relatively high at a wavelength of 1550 nanometers, laser light ranging from 1300 nanometers to 1580 nanometers may be selected when the human visual safety is a concern. As an example, other operating parameters of the laser may include a transmitting frequency ranging from 1 KHz to 200 KHz, a peak power ranging from 0.1 W to 1000 W, and a pulse width ranging from 0.5 ns to 20 ns.

The one or more lasers in each of the transmitting units may be packaged in a same package structure. An edge-emitting laser (EEL) is used as an example, at least some of the lasers packaged in the same package structure may be integrated on a same bar (bar). For example, all lasers in each of the transmitting units are integrated on the same bar to form an edge-emitting laser bar. A package module may include a plurality of edge-emitting laser bars. A vertical cavity surface emitting laser (VCSEL) is used as an example, at least some of the lasers in the same package structure are integrated into an array. For example, all the lasers in each of the transmitting unit are integrated on a same array to form a vertical cavity surface emitting laser array. A packaged module may include a plurality of vertical cavity surface emitting laser arrays. As an example, the package structure may include a substrate and a cover disposed on a surface of the substrate. An accommodation space is formed between the substrate and the cover, and a laser diode is disposed in the accommodation space.

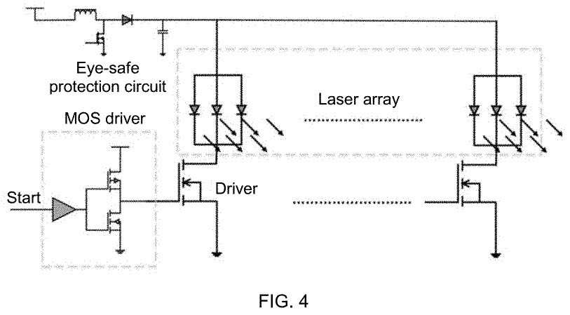

For example, one or more lasers that may emit light synchronously and are integrated on a same bar are connected to a same driver, and are driven by the same driver to emit light synchronously. A GaN (gallium nitride) driver may be used to implement high-speed, high-voltage, and high-current light source driving. FIG. 4 is a principle diagram of a laser drive circuit. In the example of FIG. 4, three lasers of each transmitting unit are driven by a driver to emit light synchronously, and lasers of a plurality of transmitting units are all packaged in a same package module. For example, a driver for driving one or more lasers of each transmitting unit to emit light synchronously may also be packaged in a same package module as the one or more lasers.

Further, the transmitting circuit 111 may further include a laser power supply. The laser power supply needs to meet requirements such as a high voltage, safety of human eyes, and an extremely fast transient response, and an LC resonant charging method is used to provide luminous energy for a laser. In some exemplary embodiments, the transmitting circuit 111 may further include an eye-safe protection circuit, which is configured to make laser light emitted by the laser meet the requirement for safety of human eyes.

In an example, the laser distance measuring device 100 may further include a transmitting control circuit. The transmitting control circuit may send a drive signal to a driver of a transmitting module, so that the driver drives a corresponding transmitting module to emit light, and may control at least one of control parameters such as a transmit power of a laser, a wavelength of emitted laser light, and a transmission direction according to the received drive signal.

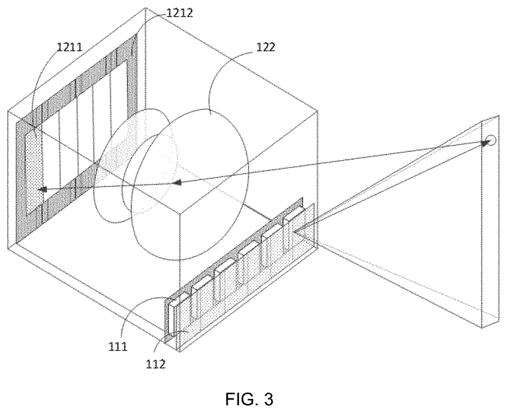

The plurality of transmitting units in the transmitting circuit 111 may sequentially emit laser light in any order, and each time when light is emitted, one field-of-view area is illuminated. An operating state of a single time of light emission may be as shown in FIG. 3. In an example, the plurality of transmitting units may emit light in a preset order. For example, the plurality of transmitting units may emit light cyclically in a spatially arranged order, for example, sequentially emit light cyclically in an order of numbers 1, 2, . . . , N, 1, 2 . . . . Alternatively, the plurality of transmitting units may emit light cyclically in another set order, for example, in an order of numbers 1, N/2+1, 2, N/2+2, . . . , N/2, N. Certainly, the plurality of transmitting units may alternatively emit light in any other set order. Alternatively, the plurality of transmitting units may emit light in a random order.

The optical transmitting system 112 may be configured to diffuse laser light emitted by each transmitting unit to a field-of-view area corresponding to the transmitting unit.

For example, the optical transmitting system 112 may include an optical diffusion sheet or a cylindrical lens group. The optical diffusion sheet may be a micro-optical diffuser structure processed on a surface of a glass material by using the micro-nano optical manufacturing technology, and is configured to obtain required light field distribution after incident light passes through the diffuser. When a cylindrical lens group is used, the cylindrical lens group may be introduced in a packaging process of a laser to regulate divergence angles of a fast axis and a slow axis of the laser, respectively, so as to make the divergence angles meet a light-emitting angle required by a required field of view. A cross-sectional shape of the cylindrical lens group includes, but is not limited to, a circle, an ellipse, a triangle, a rectangle, a trapezoid, and the like.

In some exemplary embodiments, each transmitting unit may correspond to a different optical element in the optical transmitting system 112. For example, a diffusion sheet or a cylindrical lens group may be disposed in front of each transmitting unit, and laser light emitted by different transmitting units is dispersed into their respective field-of-view areas by using different optical elements. In some exemplary embodiments, the plurality of transmitting units may also share a set of optical elements, for example, share an optical diffusion sheet, and directions of the fast axis and the slow axis of the laser are regulated to meet requirements for field-of-view angles in the horizontal and vertical directions.

In some exemplary embodiments, laser pulses transmitted by the plurality of transmitting units may cover different field-of-view areas, respectively. That is, the field-of-view areas covered by the laser pulses transmitted by the transmitting units do not overlap with each other, so that a wider field of view is covered.

In some exemplary embodiments, field-of-view areas covered by laser pulses transmitted by the plurality of transmitting units may alternatively overlap partially. For example, the field-of-view areas covered by the laser pulses transmitted by the plurality of transmitting units may overlap in a key area, thereby implementing directional enhanced perception under a strong background light condition. Cumulative signal intensity in the key area may be enhanced by overlapping a plurality of field-of-view areas in the key area, thereby improving a signal-to-noise ratio of the key area, and then improving the measurement range under a background light condition. The laser distance measuring device 100 according to some exemplary embodiments of the present disclosure may use the APD array 1211 operating in the linear mode, the dynamic range is wide, and saturation failure is less likely to occur. Therefore, returning laser pulses in the key area may be accumulated.

The key area may be an area of interest on which a user focuses. For example, the key area may be a central area of a field of view of the laser distance measuring device 100, and field-of-view areas covered by laser pulses transmitted by some or all of the transmitting units may overlap in the central area of the field of view. When the laser distance measuring device 100 is applied to a vehicle, the central area of the field of view corresponds to a road surface in front of the vehicle, and is an area that needs to be focused on during driving of the vehicle. The key area may alternatively be located at another position in the field of view of the laser distance measuring device 100 according to an actual need.

The transmitting units may have various spatial arrangement manners. For example, still referring to FIG. 2, the optical receiving system 122 may include a lens group disposed on a side of the APD array 1211, and the plurality of transmitting units may be integrally disposed on a side of the lens group. For example, as shown in FIG. 2, the plurality of transmitting units are arranged in a one-dimensional array in a plane perpendicular to an axial direction of the lens group, or may be arranged in a two-dimensional array. When being integrally disposed, the plurality of transmitting units may be packaged in one package module to reduce a quantity of packaged modules. For example, the six transmitting units shown in FIG. 2 may be packaged in a same packaged module.

In some exemplary embodiments, the plurality of transmitting units may alternatively be disposed around the lens group dispersedly. For example, the plurality of transmitting units may be disposed at four corners around the lens group, or arranged in a circle around the lens group. Disposing the plurality of transmitting units dispersedly may improve space utilization and meet a requirement of miniaturization of a laser distance measuring device. Further, when the plurality of transmitting units are disposed dispersedly, a plurality of transmitting units may also be disposed at each position, for example, a plurality of transmitting units are disposed at each of the four corners around the lens group. In this case, a plurality of transmitting units disposed at a same position may also be packaged in a same package structure.

In some exemplary embodiments, the transmitting unit and the lens group may at least partially overlap in an axial direction of the lens group. In other words, in the axial direction of the lens group, a distance between the transmitting unit and a receiving unit is not greater than a distance between the foremost end of the lens group and the receiving unit. As long as a condition that exit light of the transmitting unit is not blocked, the transmitting unit may be made closer to the receiving unit than that shown in FIG. 2, thereby making a layout more compact.

Further, the receiving circuit 120 may include a plurality of receiving units, and the plurality of receiving units and the plurality of transmitting units are in a one-to-one correspondence. Each of the receiving units may include one or more APDs in the APD array 1211, and is configured to receive at least some of returning laser pulses obtained after laser pulses transmitted by a corresponding transmitting unit is reflected back by a measured object. The plurality of receiving units may have a same shape or different shapes, and include a same quantity of APDs or different quantities of APDs, which may be specifically set according to a field-of-view area corresponding to each of the receiving units.

The plurality of receiving units may be arranged in a one-dimensional array, for example, the one-dimensional array, as shown in FIG. 2, formed by one-dimensional arrangement of six receiving units. Alternatively, the plurality of receiving units may be arranged in a two-dimensional array. In addition, the APDs in each receiving unit may also be arranged in a one-dimensional array or a two-dimensional array. Since the receiving units and the transmitting units are in a one-to-one correspondence, an arrangement manner of the receiving units is generally consistent with that of the transmitting units. For example, when the transmitting units are arranged in a 1×N one-dimensional array, the receiving units are also arranged in a 1×N one-dimensional array; when the transmitting units are arranged in an M×N two-dimensional array, the receiving units are also arranged in an M×N two-dimensional array.

Further, the plurality of receiving units may alternatively use a time-division operating mode, to cooperate with the transmitting units. Specifically, the plurality of receiving units are respectively turned on in different time windows, that is, APDs of a specific receiving unit in each time window are turned on to receive returning laser pulses converging on the APDs, and remaining APDs are turned off. Using the time-division and partitioning operating mode may reduce total power consumption of the laser distance measuring device 100, reduce a heat dissipation requirement of the APD array 1211, and also reduce design difficulty of a switching circuit. Certainly, in some exemplary embodiments, the plurality of receiving units may alternatively be turned on synchronously, but only some of the receiving units receive returning laser pulses.

Further, only one transmitting unit may be turned on and scans a corresponding field-of-view area in each time window, and returning laser pulses returned from the field-of-view area covers only a part of area of the APD array 1211, so that a one-to-one correspondence may be set between the receiving units and the transmitting units. When a transmitting unit is turned on in a time window, the receiving unit corresponding to the transmitting unit is turned on synchronously in the time window, to receive returning laser pulses of the laser pulses transmitted by the transmitting unit. In this case, other receiving units are turned off. The optical receiving system 122 may be designed accordingly, so that at least some of the returning laser pulses returned from a field-of-view area covered by laser pulses transmitted by each of the transmitting units may converge on a receiving unit corresponding to the transmitting unit.

Specifically, in each time window, a transmitting unit and a receiving unit corresponding to the transmitting unit may be turned on simultaneously, and the transmitting unit may transmit laser pulses sequence, which is processed by a receiving circuit, a sampling circuit, and an operation circuit, and finally a result of this measurement may be determined. In practical applications, in a time window, duration required from transmitting laser pulses by the transmitting circuit to obtaining a distance through calculation by the operation circuit depends on a distance between a measured object and a laser distance measuring device. The farther the distance, the longer the duration. When the object is farther away from the laser distance measuring device, a light signal reflected by the object becomes weak. When the reflected light signal is weak to a certain extent, the light signal cannot be detected by the laser distance measuring device. Therefore, a distance between the laser distance measuring device and an object corresponding to the weakest optical signal detected by the laser distance measuring device is referred to as the farthest detection distance of the laser distance measuring device. In some exemplary embodiments of the present disclosure, duration of each time window is greater than duration corresponding to the farthest detection distance, for example, the duration of each time window is at least more than five times longer than the duration corresponding to the farthest detection distance.

Further, the laser distance measuring device 100 may further include a transmitting control circuit and a receiving control circuit. The transmitting control circuit is configured to control a transmitting unit that is turned on in a current time window, and the receiving control circuit is configured to control a receiving unit that is turned on in a current time window. The transmitting control circuit and the receiving control circuit are coupled to each other. When the transmitting control circuit controls a transmitting unit to transmit laser pulses, the corresponding receiving control circuit is notified to control the corresponding receiving unit to be turned on synchronously.

The transmitting units and the receiving units may be turned on synchronously in any order for transmitting and receiving. Since the transmitting units and the receiving units correspond to a same field-of-view area, generally speaking, the corresponding transmitting unit and receiving unit are located in symmetrical positions in an array. For example, as shown in FIG. 3, a transmitting unit on the right side of the array corresponds to a receiving unit on the left side of the array.

In some exemplary embodiments, the adjacent transmitting units may be turned on in sequence to transmit laser pulses, and correspondingly, the adjacent receiving units may be turned on in sequence to receive returning laser pulses of the laser pulses. For example, the transmitting units are turned on sequentially in an order of numbers 1, 2, 3, 4, 5, and 6.

In some exemplary embodiments, the transmitting units arranged at intervals may be turned on in sequence to transmit laser pulses, and correspondingly, the receiving units arranged at intervals may be turned on in sequence to receive returning laser pulses of the laser pulses. That the transmitting units arranged at intervals are turned on in sequence indicates that two transmitting units at adjacent positions are not turned on in sequence in two adjacent time windows, but a specific turning-on sequence of the transmitting units is not limited. For example, the transmitting units may be turned on in an order of numbers 1, 4, 2, 5, 3, 6, . . . , or in an order of numbers 1, 5, 2, 6, 3 . . . , or the like.

In some exemplary embodiments, two adjacent receiving units may share some of APDs. That is, the shared APDs are always in an on state when transmitting units respectively corresponding to the two receiving units emit light, so as to receive returning laser pulses obtained after the light emitted by the two transmitting units is reflected back. More receiving units may be provided with the limited APD array 1211. For example, the first receiving unit includes APDs numbered 1, 2, 3, and 4, and the second adjacent receiving unit includes APDs numbered 4, 5, 6, and 7, and so on. As an example, when the receiving units arranged at intervals are turned on in sequence to receive returning laser pulses, adjacent receiving units may share some of APDs, so as to improve the heat dissipation effect of the APDs, and avoid overheating caused by a long time of an on state of the shared APDs.

As described above, in some exemplary embodiments, all the field-of-view areas covered by the laser pulses transmitted by some or all of the transmitting units may include the central area of the field of view of the laser distance measuring device 100. In order to cooperate with this case, in some exemplary embodiments, some or all of the receiving units may share one or more APDs located in the central area of the APD array, to receive returning laser pulses returned from the central area. Specifically, in some or all time windows, part of each laser pulses emitted by the transmitting module 110 is irradiated to the central area of the field of view, and the plurality of receiving units share the APDs in the central area of the APD array, so that a turn-on frequency of the APDs in the central area of the APD array may be improved, making the APDs turned on in a plurality of time windows to receive the returning laser pulses returned from the central area of the field of view.

In some exemplary embodiments, when all the field-of-view areas covered by the laser pulses transmitted by some or all of the transmitting units may include the central area of the field of view of the laser distance measuring device 100, a receiving unit located in a central area of the APD array 1211 is turned on synchronously with some or all of the transmitting units, to receive a returning laser pulses returned from the central area. Specifically, when some or all of the transmitting units are turned on, in addition to covering respective field-of-view areas, some laser pulses also cover the central area of the field of view. Therefore, each transmitting unit may correspond to two receiving units. One of the receiving units is configured to receive returning laser pulses from the respective field-of-view areas, and the other receiving unit is located in the central area of the APD array 1211 and is configured to receive the returning laser pulses from the central area of the field of view.

The foregoing description uses the key area covered by some or all of the transmitting units as the central area of the field of view as an example. However, it is understood that when the key area is another area of the field of view, the receiving unit should also be adjusted accordingly. Based on the foregoing design, the receiving units and the transmitting units are cooperated with each other, implementing directional enhanced perception of the key area as described above.

As shown in FIG. 2, the optical receiving system 122 may include a lens group disposed on a side of the APD array 1211. Depending on use environments, the lens group may be designed to be composed of a single lens or a plurality of lenses, and a lens surface may be a spherical surface, an aspherical surface, or a combination of spherical and aspherical surfaces. A material of the lens may include glass, plastic, or a combination of glass and plastic. Exemplarily, a thermalization design may be fully performed on a lens group structure, to compensate for an influence of temperature drift on imaging.

In some exemplary embodiments, the optical receiving system 122 may further include a micro lens array. The micro lens array may be formed integrally with the APD array 1211, for example, etched on a surface of the APD array. Alternatively, the micro lens array may be formed separately and glued to a surface of the APD array. The micro lens array may be disposed in front of the APD array 1211, so that focusing efficiency may be improved, and an effective fill factor is increased.

Exemplarily, the optical receiving system 122 may further include a narrow-band filter, and a pass-band waveband of the narrow-band filter matches an operating waveband of the optical receiving system 122, to filter out a waveband other than a transmitting waveband, and reduce interference of natural light on distance measuring. The narrow-band filter may be installed at any position in an optical receiving path, and its plane is perpendicular to an optical axis of the optical receiving path. Exemplarily, the narrow-band filter may be disposed close to the APD array 1211 to reduce an aperture of the narrow-band filter.

In some exemplary embodiments, the optical receiving system 122 may converge returning laser pulses into a range smaller than a size of the receiving unit, that is, making a range, illuminated by the returning laser pulses, of the APD array do not exceed a boundary of the receiving unit, so as to improve an energy utilization rate and thus improve a system range. In addition, crosstalk between the receiving units may be reduced.

In some exemplary embodiments, the optical receiving system 122 may converge the returning laser pulses into a range larger than the size of the receiving unit, that is, making a range, illuminated by the returning laser pulse, of the APD array cover the boundary of the receiving unit, so as to prevent the receiving unit from receiving a returning laser pulse, returned from an edge of a field-of-view area, with low signal-to-noise ratio. In this case, in order to cover complete field-of-view area, field-of-view areas covered by adjacent transmitting units partially overlap.

In some exemplary embodiments, the laser distance measuring device 100 may further include an amplifier circuit, a sampling circuit, and an operation circuit. The amplifier circuit is configured to amplify an electrical signal converted by the receiving module 120; the sampling circuit is configured to sample an amplified electrical signal and output a sampled signal; and the operation circuit is configured to obtain three-dimensional information of the measured object through calculation based on the sampled signal.

Specifically, the amplifier circuit may include a first-stage amplifier circuit and a second-stage amplifier circuit. The first-stage amplifier circuit may be configured to amplify an electrical signal output from a photoelectric conversion device, for example, converting a photocurrent signal converted by an APD into a voltage signal to provide a conversion gain. The second-stage amplifier circuit is configured to further provide gain to an electrical signal from the first-stage amplifier circuit to amplify a weak signal output by the APD to a voltage that may be identified by a comparator. For example, the first-stage amplifier circuit may include a transimpedance amplifier (TIA) array, and the second-stage amplifier circuit may include another type of signal amplifier. Exemplarily, each APD in the APD array 1211 is connected with an amplifier circuit, and the first-stage amplifier circuit or the second-stage amplifier circuit may be disposed on the signal processing chip 1212 interconnected, at the pixel level, with the APD array 1211.

The sampling circuit may be configured to sample an electrical signal amplified by the amplifier circuit. The sampling circuit may have various embodiments.

In some exemplary embodiments, the sampling circuit may include a comparator (for example, may be an analog comparator (COMP), configured to convert an electrical signal into a digital signal) and a time measurement circuit. The electrical signal amplified by the first-stage amplifier circuit or the second-stage amplifier circuit enters the time measurement circuit after passing through the comparator, and the time measurement circuit measures a time difference between transmission and reception of laser pulses sequence.

The time measurement circuit may be a Time-to-Data Converter (TDC). The TDC may be a stand-alone TDC chip; a TDC circuit that implements time measurement based on an internal delay chain of a programmable device such as a Field-Programmable Gate Array (FPGA), an Application-Specific Integrated Circuit (ASIC), or a Complex Programmable Logic Device (CPLD); a circuit structure that implements time measurement by using high frequency clock; or a circuit structure that implements time measurement in a counting manner.

Exemplarily, a first input terminal of the comparator may be configured to receive an electrical signal input from the amplifier circuit, and a second input terminal may be configured to receive a preset threshold. A comparison operation may be performed on the electrical signal and the preset threshold that are input to the comparator. An output signal of the comparator may be sent to the TDC, and the TDC may measure time information of an output signal edge of the comparator. A measured time is based on a laser transmitting signal, that is, a time difference between transmission and reception of a laser signal may be measured.

In some exemplary embodiments, the sampling circuit may include an Analog-to-Digital Converter (ADC). After an analog signal input to the sampling circuit may be converted by the ADC, a digital signal may be output to the operation circuit. Similarly, the ADC may be a stand-alone ADC chip.

A sampling signal output by the sampling circuit may be passed to the operation circuit. The operation circuit may obtain distance information of a measured object through calculation based on a time difference between transmission and reception of a laser signal and a laser transmission rate, may also obtain angle information of the measured object based on a position of an APD, and further obtain three-dimensional information of the measured object through calculation. Then, the operation circuit may also generate an image based on the calculated information, which is not limited herein. A distance and an orientation detected by the laser distance measuring device 100 may be used for remote sensing, obstacle avoidance, mapping, modeling, navigation, and the like.

To sum up, the laser distance measuring device 100 according to some exemplary embodiments of the present disclosure may use an APD array operating in a linear mode, so that a distance measurement range is large, a dynamic range is wide, and a signal-to-noise ratio is high. Therefore, interference of ambient light noise on the laser distance measuring device may be effectively reduced, and the laser distance measuring device may be adapted to a complex use environment. In addition, the laser distance measuring device 100 may use a design in which a plurality of transmitting units perform transmission in a time-division manner and transmitting units and receiving units are in a one-to-one correspondence, and no mechanical moving parts are required, so that the laser distance measuring device is small and lightweight. There is no need to align the transmitting units and the receiving units one by one for assembly, so that low assembly difficulty, good mass producibility, and high reliability may be achieved.

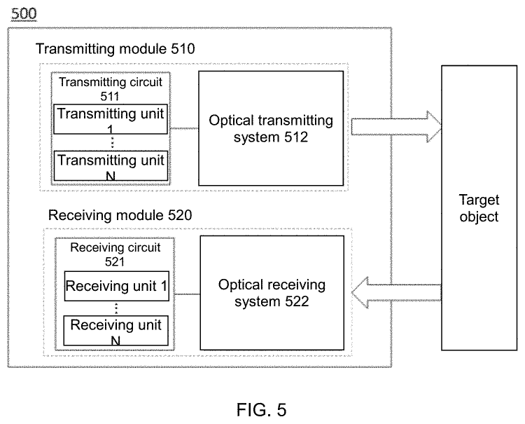

Next, a laser distance measuring device 500 according to some exemplary embodiments of the present disclosure will be described with reference to FIG. 5. Only the main structure of the laser distance measuring device 500 is described below, and specific details of some components that are same or similar as those of the laser distance measuring device 100 may be omitted.

As shown in FIG. 5, the laser distance measuring device 500 may include a transmitting module 510 and a receiving module 520. The transmitting module 510 may include a transmitting circuit 511 and an optical transmitting system 512, the transmitting circuit 511 may include a plurality of transmitting units that sequentially emit laser light, and the optical transmitting system 512 may be configured to disperse laser pulses transmitted by each of the transmitting units to a corresponding field-of-view area. The receiving module 520 may include a receiving circuit 521 and an optical receiving system 522, the receiving circuit 521 may include a plurality of receiving units, the receiving unit may be configured to receive at least some of returning laser pulses obtained after the laser pulses is reflected back by a measured object, and convert the at least some of the returning laser pulses into an electrical signal, and the optical receiving system 522 may be configured to make returning laser pulses of each field-of-view area converge on the corresponding receiving circuit.

The laser distance measuring device 500 according to some exemplary embodiments of the present disclosure may perform scanning, without a scanning system, through cooperation of the transmitting circuit 511, the optical transmitting system, the optical receiving system 522, and the receiving circuit 521, so that there is no need to accurately align the transmitting modules 510 and the receiving modules 520 one by one, and long-distance three-dimensional imaging without a mechanical moving part may be achieved.

Specifically, each transmitting unit in the transmitting circuit 511 may include one or more lasers that emit light synchronously. The plurality of transmitting units may sequentially emit laser light in different time windows, and the optical transmitting system 512 may disperse laser pulses transmitted by each of the transmitting units to a corresponding field-of-view area. Due to a limited total power, the transmitting circuit 511 is divided into a plurality of transmitting units that may be turned on in different time windows, and then the power may be intensively distributed to one or more lasers that are in each of the transmitting units, thereby increasing an optical power density per field of view, helping increase a percentage of signal light in a photon incident on the receiving module 520, improving a signal-to-noise ratio, and improving a measurement range of the laser distance measuring device 500 under a strong background light condition.

The one or more lasers in each of the transmitting units may be packaged in a same package structure. At least some of the lasers packaged in the same package structure may be integrated on a same bar or a same array. For example, all lasers in each of the transmitting units may be integrated on the same bar or the same array to form an edge-emitting laser bar or a vertical cavity surface emitting laser array. A package module may include a plurality of edge-emitting laser bars or a plurality of vertical cavity surface emitting laser arrays. As an example, the package structure may include a substrate and a cover disposed on a surface of the substrate. An accommodation space is formed between the substrate and the cover, and a laser diode is disposed in the accommodation space.

Exemplarily, one or more lasers that emit light synchronously and are integrated on a same bar or a same array may be connected to a same driver, and may be driven by the same driver to emit light synchronously. A GaN (gallium nitride) driver may be used to implement high-speed, high-voltage, and high-current light source driving.

Further, the transmitting circuit 511 may further include a laser power supply. The laser power supply needs to meet requirements such as a high voltage, safety of human eyes, and an extremely fast transient response, and an LC resonant charging method is used to provide luminous energy for a laser. In some exemplary embodiments, the transmitting circuit 511 may further include an eye-safe protection circuit, which is configured to prevent the laser from continuously emitting light when a circuit failure occurs, making laser light emitted by the laser meet the requirement for safety of human eyes.

In an example, the laser distance measuring device 500 may further include a transmitting control circuit. The transmitting control circuit may send a drive signal to a driver of a transmitting module, so that the driver drives a corresponding transmitting module to emit light, and may control at least one of control parameters such as a transmit power of a laser, a wavelength of emitted laser light, and a transmission direction according to the received drive signal.

The plurality of transmitting units in the transmitting circuit 511 may sequentially emit laser light in any order, and each time when light is emitted, one field-of-view area is illuminated. In an example, the plurality of transmitting units may emit light in a preset order. For example, the plurality of transmitting units may emit light cyclically in a spatially arranged order. Alternatively, the plurality of transmitting units may emit light cyclically in another set order. Certainly, the plurality of transmitting units may alternatively emit light in any other set order. Alternatively, the plurality of transmitting units may emit light in a random order.

The optical transmitting system 512 may be configured to diffuse laser light emitted by each transmitting unit to a field-of-view area corresponding to the transmitting unit.

Exemplarily, the optical transmitting system 512 may include an optical diffusion sheet or a cylindrical lens group. The optical diffusion sheet may be a micro-optical diffuser structure processed on a surface of a glass material by using the micro-nano optical manufacturing technology, and is configured to obtain required light field distribution after incident light passes through the diffuser. When a cylindrical lens group is used, the cylindrical lens group may be introduced in a packaging process of a laser to regulate divergence angles of a fast axis and a slow axis of the laser, respectively, so as to make the divergence angles meet a light-emitting angle required by a required field of view. A cross-sectional shape of the cylindrical lens group includes, but is not limited to, a circle, an ellipse, a triangle, a rectangle, a trapezoid, and the like.

In some exemplary embodiments, each transmitting unit may correspond to a different optical element in the optical transmitting system 512. For example, a diffusion sheet or a cylindrical lens group may be disposed in front of each transmitting unit, and laser light emitted by different transmitting units may be dispersed into their respective field-of-view areas by using different optical elements. In some exemplary embodiments, the plurality of transmitting units may also share a set of optical elements, for example, share an optical diffusion sheet, and directions of the fast axis and the slow axis of the laser are regulated to meet requirements for field-of-view angles in the horizontal and vertical directions.

In some exemplary embodiments, laser pulses transmitted by the plurality of transmitting units may cover different field-of-view areas, respectively. That is, the field-of-view areas covered by the laser pulses transmitted by the transmitting units do not overlap with each other, so that a wider field of view is covered.

In some exemplary embodiments, field-of-view areas covered by laser pulses transmitted by the plurality of transmitting units may alternatively overlap partially. For example, the field-of-view areas covered by the laser pulses transmitted by the plurality of transmitting units may overlap in a key area, thereby implementing directional enhanced perception under a strong background light condition. Cumulative signal intensity in the key area may be enhanced by overlapping a plurality of field-of-view areas in the key area, thereby improving a signal-to-noise ratio of the key area, and then improving the measurement range under a background light condition.

The key area may be an area of interest on which a user focuses. For example, the key area may be a central area of a field of view of the laser distance measuring device 500, and field-of-view areas covered by laser pulses transmitted by some or all of the transmitting units may overlap in the central area of the field of view. When the laser distance measuring device 500 is applied to a vehicle, the central area of the field of view corresponds to a road surface in front of the vehicle, and is an area that needs to be focused on during driving of the vehicle. The key area may alternatively be located at another position in the field of view of the laser distance measuring device 500 according to an actual need.

The transmitting units may have various spatial arrangement manners. For example, the optical receiving system 522 may include a lens group disposed on a side of an APD array, and the plurality of transmitting units may be integrally disposed on a side of the lens group. When being integrally disposed, the plurality of transmitting units may be packaged in one package module to reduce a quantity of packaged modules. In some exemplary embodiments, the plurality of transmitting units may alternatively be disposed around the lens group dispersedly. For example, the plurality of transmitting units may be disposed at four corners around the lens group, or arranged in a circle around the lens group. Disposing the plurality of transmitting units dispersedly may improve space utilization and meet a requirement of miniaturization of a laser distance measuring device. Further, when the plurality of transmitting units are disposed dispersedly, a plurality of transmitting units may also be disposed at each position, for example, a plurality of transmitting units are disposed at each of the four corners around the lens group. In this case, a plurality of transmitting units disposed at a same position may also be packaged in a same package structure.

In some exemplary embodiments, the transmitting unit and the lens group may at least partially overlap in an axial direction of the lens group. In other words, in the axial direction of the lens group, a distance between the transmitting unit and a receiving unit is not greater than a distance between the foremost end of the lens group and the receiving unit.

In some exemplary embodiments, the receiving circuit 520 may include an APD array, and each of the receiving units may include one or more APDs in the APD array. Further, the APD array may be an APD array operating in a linear mode. The plurality of receiving units may have a same shape or different shapes, and include a same quantity of APDs or different quantities of APDs, which may be specifically set according to a field-of-view area corresponding to each of the receiving units.

The plurality of receiving units may be arranged in a one-dimensional array, for example, a one-dimensional array formed by one-dimensional arrangement of six receiving units. Alternatively, the plurality of receiving units may be arranged in a two-dimensional array. In addition, the APDs in each receiving unit may also be arranged in a one-dimensional array or a two-dimensional array. Since the receiving units and the transmitting units are in a one-to-one correspondence, an arrangement manner of the receiving units is generally consistent with that of the transmitting units.

Further, the plurality of receiving units may alternatively use a time-division operating mode, to cooperate with the transmitting units. Specifically, the plurality of receiving units are respectively turned on in different time windows, that is, a specific receiving unit in each time window is turned on to receive returning laser pulses converging on the receiving unit, and remaining receiving units are turned off. Using the time-division and partitioning operating mode may reduce total power consumption of the laser distance measuring device 500, reduce a heat dissipation requirement of the receiving units, and also reduce design difficulty of a switching circuit. Certainly, in some exemplary embodiments, the plurality of receiving units may alternatively be turned on synchronously, but only some of the receiving units receive returning laser pulses.

Further, since only one transmitting unit is turned on and scans a corresponding field-of-view area in each time window, when a transmitting unit is turned on in a time window, the receiving unit corresponding to the transmitting unit may be turned on synchronously in the time window, to receive returning laser pulses of laser pulses transmitted by the transmitting unit. In this case, other receiving units may be turned off. The optical receiving system 522 may be designed accordingly, so that at least some of returning laser pulses returned from a field-of-view area covered by laser pulses transmitted by each of the transmitting units may converge on a receiving unit corresponding to the transmitting unit.

The transmitting units and the receiving units may be turned on synchronously in any order for transmitting and receiving. Since the transmitting units and the receiving units correspond to a same field-of-view area, in some exemplary embodiments, the adjacent transmitting units are turned on in sequence to transmit laser pulses.

In some exemplary embodiments, the transmitting units arranged at intervals may be turned on in sequence to transmit laser pulses, and correspondingly, the receiving units arranged at intervals may be turned on in sequence to receive returning laser pulses of the laser pulses. That the transmitting units arranged at intervals are turned on in sequence indicates that two transmitting units at adjacent positions are not turned on in sequence in two adjacent time windows, but a specific turning-on sequence of the transmitting units is not limited.

In some exemplary embodiments, two adjacent receiving units may share some of APDs, so as to use the limited APD array 1211 to set more receiving units. As an example, when the receiving units arranged at intervals are turned on in sequence to receive returning laser pulses, adjacent receiving units may share some of APDs, so as to improve the heat dissipation effect of the APDs, and avoid overheating caused by a long time of an on state of the shared APDs.

As described above, in some exemplary embodiments, all the field-of-view areas covered by the laser pulses transmitted by some or all of the transmitting units may include the central area of the field of view of the laser distance measuring device 500. In order to cooperate with this case, as an implementation, some or all of the receiving units may share one or more APDs located in the central area of the APD array, to receive returning laser pulses returned from the central area. In some exemplary embodiments, when all the field-of-view areas covered by the laser pulses transmitted by some or all of the transmitting units include the central area of the field of view of the laser distance measuring device 500, a receiving unit located in a central area of the APD array 1211 is turned on synchronously with some or all of the transmitting units, to receive returning laser pulses returned from the central area.

The foregoing description uses the key area covered by some or all of the transmitting units as the central area of the field of view as an example. However, it is understood that when the key area is another area of the field of view, the receiving unit should also be adjusted accordingly. Based on the foregoing design, the receiving units and the transmitting units are cooperated with each other, implementing directional enhanced perception of the key area as described above.

The optical receiving system 522 may include a lens group disposed on a side of the receiving circuit 521. Depending on use environments, the lens group may be designed to be composed of a single lens or a plurality of lenses, and a lens surface may be a spherical surface, an aspherical surface, or a combination of spherical and aspherical surfaces. A material of the lens may include glass, plastic, or a combination of glass and plastic. Exemplarily, a thermalization design may be fully performed on a lens group structure, to compensate for an influence of temperature drift on imaging. In some exemplary embodiments, the optical receiving system 522 may further include a micro lens array. The micro lens array may be formed integrally with the APD array, for example, etched on a surface of the APD array. Alternatively, the micro lens array may be formed separately and glued to a surface of the APD array. The micro lens array is disposed in front of the APD array, so that focusing efficiency may be improved, and an effective fill factor is increased. Exemplarily, the optical receiving system 522 may further include a narrow-band filter, and a pass-band waveband of the narrow-band filter matches an operating waveband of the optical receiving system 522, to filter out a waveband other than a transmitting waveband, and reduce interference of natural light on distance measuring.

In some exemplary embodiments, the optical receiving system 522 makes the returning laser pulses converge into a range smaller than a size of the receiving unit, that is, making a range, illuminated by the returning laser pulses, of the APD array do not exceed a boundary of the receiving unit, so as to improve an energy utilization rate and thus improve a system range. In addition, crosstalk between the receiving units may be reduced.

In some exemplary embodiments, the optical receiving system 522 makes the returning laser pulses converge into a range larger than the size of the receiving unit, that is, making a range, illuminated by the returning laser pulse, of the APD array cover the boundary of the receiving unit, so as to prevent the receiving unit from receiving a returning laser pulse, returned from an edge of a field-of-view area, with low signal-to-noise ratio. In this case, in order to cover complete field-of-view area, field-of-view areas covered by adjacent transmitting units partially overlap.

In some exemplary embodiments, the laser distance measuring device 500 may further include an amplifier circuit, a sampling circuit, and an operation circuit. The amplifier circuit is configured to amplify an electrical signal converted by the receiving module 520; the sampling circuit is configured to sample an amplified electrical signal and output a sampled signal; and the operation circuit is configured to obtain three-dimensional information of the measured object through calculation based on the sampled signal. For specific details of the amplifier circuit, the sampling circuit, and the operation circuit, reference may be made to the foregoing description. Details are not described herein.

To sum up, the laser distance measuring device 500 according to some exemplary embodiments of the present disclosure may use a design in which a plurality of transmitting units perform transmission in a time-division manner and transmitting units and receiving units are in a one-to-one correspondence, and no mechanical moving parts are required, so that the laser distance measuring device is small and lightweight. There is no need to align the transmitting units and the receiving units one by one for assembly, so that low assembly difficulty, good mass producibility, and high reliability may be achieved.

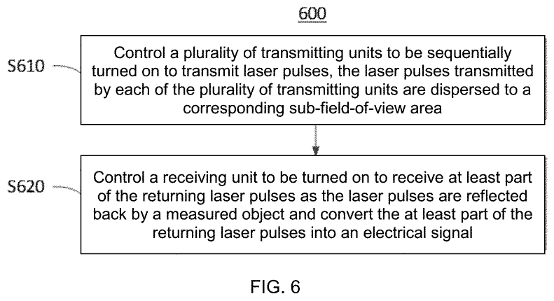

Another aspect of some exemplary embodiments of the present disclosure provides a laser distance measuring method. FIG. 6 shows a flowchart of a laser distance measuring method 600. The laser distance measuring method 600 may be implemented by the laser distance measuring device according to any one of the foregoing exemplary embodiments. Only the main steps of the laser distance measuring method 600 will be described below, and some of details described above may be omitted.

As shown in FIG. 6, the laser distance measuring method 600 may include the following steps:

Step S610: controlling a plurality of transmitting units to be turned on in sequence to transmit laser pulses, where laser pulses transmitted by each of the transmitting units is dispersed to a corresponding field-of-view area; and

Step S620: controlling a receiving unit to be turned on, to receive at least some of returning laser pulses after the laser pulses is reflected back by a measured object and convert the at least some of the returning laser pulses into an electrical signal.

Exemplarily, step S610 may be implemented by a transmitting control circuit.

In some exemplary embodiments, the controlling of the plurality of transmitting units to be turned on in sequence to transmit the laser pulses includes: controlling the plurality of transmitting units to emit light in a set order or in a random order.

In some exemplary embodiments, the laser pulses transmitted by the plurality of transmitting units cover different field-of-view areas, respectively.

In some exemplary embodiments, the field-of-view areas covered by the laser pulses transmitted by the plurality of transmitting units overlap partially.

Exemplarily, step S620 may be specifically implemented by a receiving control circuit.

In some exemplary embodiments, the receiving control circuit may include an APD array, and each of the receiving units may include one or more APDs in the APD array. All field-of-view areas covered by laser pulses transmitted by some or all of the transmitting units may include a central area of a field of view of the laser distance measuring device. The controlling of the receiving unit to be turned on includes: controlling a receiving unit located in a central area of the APD array to be turned on synchronously with some or all of the transmitting units, to receive returning laser pulses returned from the central area.

In some exemplary embodiments, the controlling of the receiving unit to be turned on includes: controlling the plurality of receiving units to be turned on in different time windows, respectively.

In some exemplary embodiments, the receiving units and the transmitting units are in a one-to-one correspondence, and the controlling of the receiving unit to be turned on includes: controlling each of the receiving units and the transmitting unit corresponding to the receiving unit to be turned on synchronously, to receive returning laser pulses of laser pulses transmitted by the transmitting unit.

In some exemplary embodiments, the controlling of each of the receiving units and the transmitting unit corresponding to the receiving unit to be turned on synchronously includes: controlling adjacent transmitting units to be turned on in sequence to transmit laser pulses, and controlling adjacent receiving units to be turned on in sequence to receive returning laser pulses of the laser pulses.

In some exemplary embodiments, the controlling of each of the receiving units and the transmitting unit corresponding to the receiving unit to be turned on synchronously includes: controlling the transmitting units arranged at intervals to be turned on in sequence to transmit laser pulses, and controlling the receiving units arranged at intervals to be turned on in sequence to receive returning laser pulses of the laser pulses.

The laser distance measuring method 600 in the embodiments of the present disclosure uses a control method of controlling a plurality of transmitting units to perform transmission in a time-division manner, and controlling the transmitting units and the receiving units to be turned on in a one-to-one correspondence, so that laser distance measuring may be implemented without controlling movement of a mechanical moving part.

Some exemplary embodiments of the present disclosure further provide a movable platform. The movable platform may include any one of the laser distance measuring devices described above and a movable platform body, and the laser distance measuring device is disposed on the movable platform body. Further, the movable platform includes, but is not limited to, at least one of an unmanned air vehicle (UAV), a vehicle, a robot, or a remote control vehicle. Exemplarily, when the laser distance measuring device is applied to a UAV, the movable platform body is a body of the UAV. When the laser distance measuring device is applied to a vehicle, the movable platform body is a body of the vehicle. Since the movable platform uses the laser distance measuring device according to some exemplary embodiments of the present disclosure, the movable platform also has the advantages as described above.

Although some exemplary embodiments have been described herein with reference to the accompanying drawings, it should be understood that the foregoing exemplary embodiments are for example only, and the scope of the present disclosure is not limited thereto. Various changes and modifications may be made therein by a person of ordinary skill in the art without departing from the scope and spirit of the present disclosure. All such changes and modifications are intended to be included within the scope of the present disclosure as claimed in the appended claims.

A person of ordinary skill in the art may understand that units and algorithm steps of various examples described with reference to the exemplary embodiments disclosed in this disclosure may be implemented by using electronic hardware, or a combination of a computer software and electronic hardware. Whether these functions are performed by using hardware or software depends on a specific application and design constraints of the technical solution. A person skilled in the art may use different methods to implement the described functions for each specific application, but it should not be considered that the implementation goes beyond the scope of the present disclosure.

In some exemplary embodiments provided in the present disclosure, it should be understood that the disclosed devices and method may be implemented in other manners. For example, the device exemplary embodiments described above are merely examples. For example, the unit division is merely logical function division and there may be other division in actual implementation. For example, a plurality of units or components may be combined or integrated into another device, or some features may be omitted or may not be performed.

In the disclosure provided herein, a large number of specific details are described. However, it is understood that the embodiments of the present disclosure may be practiced without the specific details. In some exemplary embodiments, well-known methods, structures and techniques are not shown in detail to avoid obscuring the understanding of this disclosure.

Similarly, it should be understood that in order to simplify the present disclosure and help understand one or more aspects of the present disclosure, in the description of exemplary embodiments of the present disclosure, various features in the present disclosure are sometimes grouped together into a single embodiment, figure, or description thereof. However, the method of the present disclosure should not be interpreted as reflecting an intention that the disclosure requires more features than are explicitly recited in each claim. Rather, as the corresponding claims reflect, the invention point(s) lies in the fact that the corresponding technical problem may be resolved with features less than all features of a single disclosed embodiment. Thus, the Claims following the Detailed Description are hereby incorporated into this Detailed Description, with each claim standing on its own as a separate embodiment of the present disclosure.

Those skilled in the art understand that, all of the features disclosed in this disclosure (including the accompanying claims, abstract and drawings) and any method or all processes or units of any device so disclosed may be combined, except that the features are mutually exclusive. Each feature disclosed in this disclosure (including accompanying claims, abstract and drawings) may be replaced by alternative features serving the same, equivalent or similar purpose, unless explicitly stated otherwise.

In addition, those skilled in the art understand that, although some exemplary embodiments herein include some features included in other embodiments but not other features thereof, a combination of features of different embodiments falls within the scope of the present disclosure and forms a different embodiment. For example, in the claims, any one of the exemplary embodiments may be used in a combination.

Various component embodiments of the present disclosure may be implemented in hardware, or in software modules running on one or more processors, or in a combination thereof. Those skilled in the art should understand that a microprocessor or a digital signal processor (DSP) may be used in practice to implement some or all of the functions of some modules according to some exemplary embodiments of the present disclosure. The present disclosure may also be implemented as an apparatus program (such as a computer program, or a computer program product) for performing part or all of the methods described herein. Such a program implementing the present disclosure may be stored on a computer-readable medium, or may be in the form of one or more signals. Such signals may be downloaded from the Internet, or provided on carrier signals, or in any other form.

It should be noted that, the foregoing exemplary embodiments illustrate rather than limit the present disclosure, and those skilled in the art may design alternative embodiments without departing from the scope of the appended claims. In the claims, any reference signs between brackets should not be constructed as a limitation on the claims. The present disclosure may be implemented with the assistance of hardware including several different components and the assistance of a properly programmed computer. In the unit claims where several devices are listed, several of the devices may be embodied by the same hardware item. The use of words such as first, second, and third do not indicate any order. The words may be interpreted as names.

What is claimed is:

1. A laser distance measuring device, comprising:
a transmitting module, including:
a transmitting circuit configured to transmit laser pulses, and
an optical transmitting system configured to disperse the laser pulses to cover a target field-of-view area; and
a receiving module, including:
a receiving circuit, including an avalanche photodiode (APD) array operating in a linear mode, and configured to:
receive at least some of returning laser pulses as the laser pulses are reflected back by a measured object, and
convert the at least some of the returning laser pulses into an electrical signal, and
an optical receiving system, configured to converge the returning laser pulses on the APD array.

2. The laser distance measuring device according to claim 1, wherein
the transmitting circuit includes a plurality of transmitting units to sequentially emit the laser pulses; and
the optical transmitting system disperses the laser pulses transmitted by each of the plurality of transmitting units to a corresponding sub-field-of-view area of the target field-of-view area.

3. The laser distance measuring device according to claim 2, wherein each of the plurality of transmitting units corresponds to a different optical element in the optical transmitting system.

4. The laser distance measuring device according to claim 2, wherein
the optical receiving system includes a lens group disposed on a side of the APD array; and
the plurality of transmitting units is integrally disposed on a side of the lens group or dispersedly disposed around the lens group.

5. The laser distance measuring device according to claim 4, wherein the plurality of transmitting units and the lens group at least partially overlap in an axial direction of the lens group.

6. The laser distance measuring device according to claim 2, wherein
the receiving circuit includes a plurality of receiving units in a one-to-one correspondence with the plurality of transmitting units; and
each of the plurality of receiving units includes one or more APDs in the APD array to receive at least some of the returning laser pulses after the laser pulses transmitted by a corresponding transmitting unit are reflected back by the measured object.

7. The laser distance measuring device according to claim 6, wherein the optical receiving system converges the returning laser pulses into a range smaller than a size of the corresponding receiving unit.

8. The laser distance measuring device according to claim 6, wherein
adjacent transmitting units of the plurality of transmitting units has corresponding sub-field-of-view areas that partially overlap; and
the optical receiving system converges the returning laser pulses into a range larger than a size of a corresponding receiving unit of the plurality of receiving unit.

9. The laser distance measuring device according to claim 6, wherein the plurality of receiving units is respectively turned on in different time windows.

10. The laser distance measuring device according to claim 9, wherein a receiving unit of the plurality of receiving units and its corresponding transmitting unit are turned on synchronously to receive the returning laser pulses of the laser pulses transmitted by the corresponding transmitting unit.

11. The laser distance measuring device according to claim 6, wherein
adjacent transmitting units of the plurality of transmitting units are turned on in sequence to transmit the laser pulses; and
adjacent receiving units of the plurality of receiving units are turned on in sequence to receive the returning laser pulses of the laser pulses.

12. The laser distance measuring device according to claim 6, wherein
the plurality of transmitting units is arranged at intervals and is sequentially turned on to transmit laser pulses; and
the plurality of receiving units is arranged at intervals and is sequentially turned on to receive the returning laser pulses.

13. The laser distance measuring device according to claim 6, wherein two adjacent receiving units of the plurality of receiving units share some of the APDs.

14. The laser distance measuring device according to claim 13, wherein
sub-field-of-view areas covered by the laser pulses transmitted by at least some of the plurality of transmitting units include a central area of a field of view of the laser distance measuring device; and
at least some of the plurality of receiving units share an APD located in a central area of the APD array, so as to receive the returning laser pulses returned from the central area of the field of view of the laser distance measuring device.

15. The laser distance measuring device according to claim 6, wherein
sub-field-of-view areas covered by laser pulses transmitted by at least some of the plurality of transmitting units include a central area of a field of view of the laser distance measuring device; and
a receiving unit located in a central area of the APD array is turned on synchronously with the at least some of the plurality of transmitting units, so as to receive the returning laser pulses returned from the central area of the field of view of the laser distance measuring device.

16. The laser distance measuring device according to claim 6, wherein
the optical receiving system includes a lens group coaxially disposed in front of the APD array; and
the plurality of receiving units share the lens group.

17. The laser distance measuring device according to claim 1, wherein
the optical receiving system further includes a narrow-band filter; and
a pass-band waveband of the narrow-band filter matches an operating waveband of the optical receiving system to filter out a waveband other than a transmitting waveband.

18. The laser distance measuring device according to claim 1, wherein the optical receiving system further includes a micro lens array formed on a surface of the APD array through etching, or glued onto a surface of the APD array.

19. A laser distance measuring device, comprising:
a transmitting module, including:
a transmitting circuit including a plurality of transmitting units to sequentially emit laser pulses, and
an optical transmitting system configured to disperse the laser pulses transmitted by each of the transmitting units to a corresponding sub-field-of-view area of a target field-of-view area; and
a receiving module, including:
a receiving circuit, including a plurality of receiving units, and configured to:
receive at least some of the returning laser pulses as the laser pulses are reflected back by a measured object, and
convert the at least some of the returning laser pulses into an electrical signal, and
an optical receiving system, configured to converge the returning laser pulses of the sub-field-of-view areas on the receiving circuit.

20. A movable platform, comprising:
a movable platform body; and
a laser distance measuring device disposed on the movable platform body, including:
a transmitting module, including:
a transmitting circuit configured to transmit laser pulses, and
an optical transmitting system configured to disperse the laser pulses to cover a target field-of-view area, and
a receiving module, including:
a receiving circuit, including an avalanche photodiode (APD) array operating in a linear mode and configured to:
receive at least some of returning laser pulses as the laser pulses are reflected back by a measured object, and
convert the at least some of the returning laser pulses into an electrical signal, and
an optical receiving system, configured to converge the returning laser pulses on the APD array.
